(19) United States
(12) Patent Application Publication
(10) Pub. No.: US 2020/0398301 A1
(43) Pub. Date: Dec. 24, 2020

(54) OFF-LINE CLEANING APPARATUS FOR PAINTING MACHINE

(71) Applicant: GAC HONDA AUTOMOBILE CO., LTD., Guangzhou, Guangdong (CN)

(72) Inventors: Deshan Duan, Guangzhou, Guangdong (CN); Jian Li, Guangzhou, Guangdong (CN); Haoqiang Chen, Guangzhou, Guangdong (CN); Jingcheng Wang, Guangzhou, Guangdong (CN); Rui Xu, Guangzhou, Guangdong (CN)

(21) Appl. No.: 16/979,166

(22) PCT Filed: Dec. 10, 2018
(86) PCT No.: PCT/CN2018/119980

§ 371 Date: Sep. 8, 2020

(30) Foreign Application Priority Data
Mar. 8, 2018 (CN) 201810190520.1

(51) Int. Cl. B05B 15/55; B08B 9/032

(52) U.S. Cl. CPC B05B 15/55; B08B 9/0325; B08B 9/0323

(57) ABSTRACT

An off-line cleaning apparatus for a painting machine (6) mainly comprises a body (16), and a solvent tank (1), a solvent pipe (2) a compressed air pipe (3), a main cleaning pipe (4), and a test pipe (11) arranged inside the body (16). The solvent tank (1) communicates with the main cleaning pipe (4) via the solvent pipe (2) in which a conveying pump (10) is provided. The compressed air pipe (3) communicates with the main cleaning pipe (4) so as to introduce compressed air into the main cleaning pipe (4). The main cleaning pipe (4) is provided with first branch cleaning pipes (4.1) and a second branch cleaning pipe (4.2). On the basis of the above-described structures, the off-line cleaning apparatus is able to thoroughly clean mixer pipes (5) and the painting machine (6), and ensures painting quality of vehicle bumpers.

### FIELD OF THE INVENTION

The invention relates to the technical field of automobile manufacturing, and in particular to an off-line cleaning apparatus for a painting machine.

### BACKGROUND OF THE INVENTION

A painting process of an automobile bumper comprises electrostatic spraying of a mixture of a varnish paint and a curing agent mixed through mixer pipes by a painting system. If a colored varnish in the mixer pipes is not cleaned for a long time after mixing, it will easily result in a phenomenon of paint hanging on the wall, which is the so-called paint scales. In general, paint scales will be generated after a painting machine and the mixer pipes are used for two weeks. These paint scales are difficult to clean thoroughly every time a colored varnish is changed, so that paint black spots appear on first few bumpers after the colored varnish is changed, which results in poor quality and affects painting quality. Accordingly, the few bumpers are needed to be repainted.

At present, the aforementioned problems can only be solved by shortening maintenance cycle of the painting machine and directly replacing the mixer pipes and other related parts. This solution has led to shortcomings of short service life of the mixer pipes, high consumption of consumables, high maintenance cost of the painting machine, and the like.

### SUMMARY OF THE INVENTION

In order to solve the aforementioned technical problems, an off-line cleaning apparatus for a painting machine is provided in the invention, which is able to thoroughly clean mixer pipes and the painting machine, prolong service life of the mixer pipes and the painting machine while ensuring painting quality of vehicle bumpers, reduce consumption of consumables, and reduce maintenance costs of the painting machine.

In view of this, the off-line cleaning apparatus for the painting machine provided in the invention comprises a solvent tank, a solvent pipe, a compressed air pipe, and a main cleaning pipe; the solvent tank communicates with the main cleaning pipe through the solvent pipe, the compressed air pipe communicates with the main cleaning pipe; and the main cleaning pipe is provided with first cleaning branch pipes equipped with mixer pipe interfaces for cleaning mixer pipes and a second cleaning branch pipe equipped with a painting machine interface for cleaning a painting machine.

In a preferable embodiment, each of the solvent pipe, the compressed air pipe, the first cleaning branch pipes and the second cleaning branch pipe is provided with a control valve.

In a preferable embodiment, the off-line cleaning apparatus for the painting machine further comprises a control panel and a central controller; the painting machine, the control panel, and the control valves are all electrically connected with the central controller.

In a preferable embodiment, the central controller is a PLC.

In a preferable embodiment, the off-line cleaning apparatus for the painting machine further comprises a test pipe, and the test pipe is provided with a bearing air branch pipe, an atomization air branch pipe, an inner shaping air branch pipe and an outer shaping air branch pipe, which all communicate with the painting machine interface.

In a preferable embodiment, the off-line cleaning apparatus for the painting machine further comprises a body in which the solvent tank, the solvent pipe, the compressed air pipe, the main cleaning pipe and the test pipe are arranged; the mixer pipe interfaces and the painting machine interface are fixed to the body; and the body is also provided with a first air interface communicated with the compressed air pipe and a second air interface communicated with the test pipe.

In a preferable embodiment, the body is provided with a recycling tank, and the solvent tank is arranged below the recycling tank; the recycling tank is provided with a recycling pipe communicated with the solvent tank; the mixer pipe interfaces and the painting machine interface are arranged above the recycling tank, and a spray nozzle of the painting machine is facing the recycling tank when the painting machine is installed to the painting machine interface.

In a preferable embodiment, the test pipe is further provided with a valve testing branch pipe, and the valve testing branch pipe is provided with a trigger valve interface for testing a trigger valve and a color-changing valve interface for testing a color-changing valve.

In a preferable embodiment, the solvent pipe is provided with a delivery pump.

In a preferable embodiment, each of the first cleaning branch pipes is provided with a solvent filling port.

The following beneficial effects are achieved through implementation of embodiments of the invention.

The off-line cleaning apparatus for a painting machine provided in the invention comprises a solvent tank, a solvent pipe, a compressed air pipe, and a main cleaning pipe; the solvent tank communicates with the main cleaning pipe through the solvent pipe, the compressed air pipe communicates with the main cleaning pipe; and the main cleaning pipe is provided with first cleaning branch pipes equipped with mixer pipe interfaces for cleaning mixer pipes and a second cleaning branch pipe equipped with a painting machine interface for cleaning a painting machine. Based on the above structure, when the off-line cleaning apparatus is used to clean the mixer pipes and the painting machine, a solvent is introduced into the main cleaning pipe from the solvent tank through the solvent pipe and is mixed with the compressed air introduced through the compressed air pipe, and then is sprayed out from the first cleaning branch pipes and the second cleaning branch pipe respectively, so as to carry out high-pressure flushing on the mixer pipes and the painting machine, so that paint scales in the mixer pipes and the painting machine are thoroughly removed. The off-line cleaning apparatus for the painting machine can solve the problem of paint black spots on bumpers caused by paint scales, prolong the service life of the mixer pipes and the painting machine while ensuring painting quality of the bumpers, save consumption of consumables, and reduce maintenance costs of the painting machine.

### BRIEF DESCRIPTION OF THE DRAWINGS

FIG. 1 is a pipeline diagram of an off-line cleaning apparatus for a painting machine according to an embodiment of the invention.

FIG. 2 is a flow chart of controlling an off-line cleaning apparatus of a painting machine according to an embodiment of the invention.

FIG. 3 is a schematic diagram of a control panel according to an embodiment of the invention.

FIG. 4 is a left view of an off-line cleaning apparatus for a painting machine according to an embodiment of the invention.

FIG. 5 is a front view of an off-line cleaning apparatus for a painting machine according to an embodiment of the invention.

FIG. 6 is a right view of an off-line cleaning apparatus for a painting machine according to an embodiment of the invention.

### DESCRIPTION OF REFERENCE SIGNS

1, solvent tank; 2, solvent pipe; 3, compressed air pipe; 4, main cleaning pipe; 4.1, first cleaning branch pipe; 4.11, mixer pipe interface; 4.2, second cleaning branch pipe; 4.21, painting machine interface; 5, mixer pipe; 6, painting machine; 7, control valve; 8, check valve; 9, stop valve; 10, delivery pump; 11, test pipe; 11.1, bearing air branch pipe; 11.2, atomization air branch pipe; 11.3, inner shaping air branch pipe; 11.4, outer shaping air branch pipe; 11.5, valve testing branch pipe; 11.51, trigger valve interface; 11.52, color-changing valve interface; 12, air pressure regulating valve; 13, air throttle valve; 14, control panel; 14.1, GOT interface; 14.2, control button; 15, central controller; 16, body; 16.1, recycling tank; 16.2, recycling pipe; 16.3, first air interface; 16.4, second air interface; and 17, pressure gauge.

### DETAILED DESCRIPTION OF PREFERRED EMBODIMENTS

The technical solutions in the embodiments of the invention will be clearly and completely described below in conjunction with the accompanying drawings in the embodiments of the invention. Obviously, the described embodiments are only a part of the embodiments of the invention, rather than all the embodiments. Based on the embodiments of the invention, all other embodiments obtained by those skilled in the art without creative work shall fall within the protection scope of the invention.

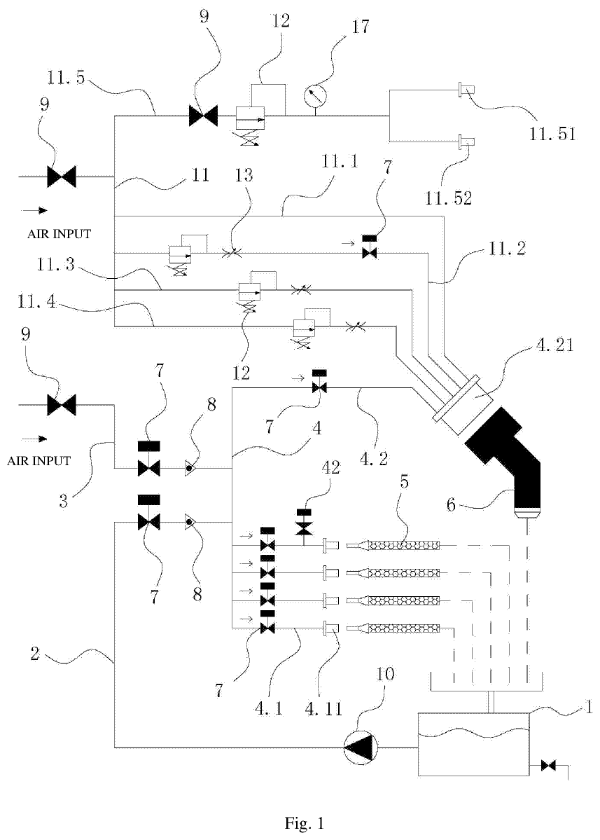

Refer to FIG. 1. An off-line cleaning apparatus for a painting machine 6 according to an embodiment of the invention mainly comprises a solvent tank 1, a solvent pipe 2, a compressed air pipe 3, and a main cleaning pipe 4. The solvent tank 1 communicates with the main cleaning pipe 4 through the solvent pipe 2. The compressed air pipe 3 communicates with the main cleaning pipe 4 for providing compressed air to the main cleaning pipe 4. The compressed air may be directly supplied by a workshop or by an air compressor. The main cleaning pipe 4 is provided with first cleaning branch pipes 4.1 and a second cleaning branch pipe 4.2. The first cleaning branch pipes 4.1 are equipped with mixer pipe interfaces 4.21 for cleaning mixer pipes 5, and the second cleaning branch pipe 4.2 is equipped with a painting machine interface 4.21 for cleaning the painting machine 6. During cleaning, the mixer pipes 5 are installed to the mixer pipe interfaces 4.11 to communicate with the first cleaning branch pipes 4.1, respectively. The painting machine 6 is installed to the painting machine interface 4.21 to communicate with the second cleaning branch pipe 4.2. Preferably, in order to increase the number of the mixer pipes 5 to be cleaned each cleaning, a plurality of first cleaning branch pipes 4.1 may be arranged in parallel, and the first cleaning branch pipes 4.1 are each numbered correspondingly, which is convenient for selecting the mixer pipes 5 to be cleaned. Based on the above structure, when the off-line cleaning apparatus is used to clean the mixer pipes 5 and the painting machine 6, a solvent is introduced into the main cleaning pipe 4 from the solvent tank 1 through the solvent pipe 2 and is mixed with the compressed air introduced through the compressed air pipe 3, and then is sprayed out from the first cleaning branch pipes 4.1 and the second cleaning branch pipe 4.2 respectively, so as to carry out high-pressure flushing on the mixer pipes 5 and the painting machine 6, so that paint scales in the mixer pipes 5 and the painting machine 6 are thoroughly removed. The off-line cleaning apparatus for the painting machine can solve the problem of paint black spots on bumpers caused by paint scales, prolong the service life of the mixer pipes 5 and the painting machine 6 while ensuring painting quality of the bumpers, reduce consumption of consumables and reduce maintenance costs of the painting machine.

Further, as shown in FIG. 1. Each of the solvent pipe 2, the compressed air pipe 3, the first cleaning branch pipes 4.1 and the second cleaning branch pipe 4.2 is provided with a control valve for controlling opening and closing of the pipes. A user can control a cleaning process by manipulating the control valves 7. The solvent pipe 2 and the compressed air pipe 3 are each provided with a check valve 8 to prevent backflow of the compressed air and the solvent. The compressed air pipe 3 is also provided with a stop valve 9 for controlling entry of compressed air. In addition, the solvent pipe 2 is also provided with a delivery pump 10 that provides power for flow of the solvent, and the delivery pump 10 is preferably a diaphragm pump.

Furthermore, as shown in FIG. 1, the off-line cleaning apparatus further comprises a test pipe 11 for supplying the painting machine 6 with compressed air required for normal operation of the painting machine 6. Similarly, the compressed air in the test pipe 11 can also be supplied directly by a workshop or supplied by an air compressor, and the test pipe 11 is also provided with a stop valve 9 for controlling entry of compressed air. The test pipe 11 is provided with a bearing air branch pipe 11.1, an atomization air branch pipe 11.2, an inner shaping air branch pipe 11.3 and an outer shaping air branch pipe 11.4, in order to meet test requirements of the painting machine 6 in actual working conditions. The bearing air branch pipe 11.1 is used for supplying an air motor in the painting machine 6 with compressed air necessary for floating bearings. The atomization air branch pipe 11.2 is used to provide compressed air necessary for atomizing a paint. The inner shaping air branch pipe 11.3 and the outer shaping air branch pipe 11.4 are used to provide compressed air for adjusting a shape of paint spraying. The bearing air branch pipe 11.1, the atomization air branch pipe 11.2, the inner shaping air branch pipe 11.3 and the outer shaping air branch pipe 11.4 all communicate with the painting machine interface 4.21. Based on the above structure, the painting machine 6 is tested directly after being cleaned. The compressed air required for normal operation of the painting machine 6 is supplied to the painting machine 6 through the test pipe 11 and the paining machine interface 4.21, so as to simulate actual working conditions of the painting machine 6. In this way, the painting machine 6 can be tested off-line without dismantling the painting machine 6, which ensures effectiveness of the painting machine 6 after it goes online. Also, the test process is easy to operate and has no unnecessary operations, which greatly reduces workload of maintenance of the painting machines 6 and improves efficiency of maintenance of the painting machine 6. Similarly, the atomization air branch pipe 11.2 is also provided with a control valve 7, and a user can control the test process by manipulating the control valve 7. In addition, each of the atomization air branch pipe 11.2, the inner shaping air branch pipe 11.3, and the outer shaping air branch pipe 11.4 is provided with an air pressure regulating valve 12 and an air throttle valve 13, so as to ensure that a pressure and flow of the compressed air entering the painting machine 6 can meet normal operation requirements of the painting machine 6.

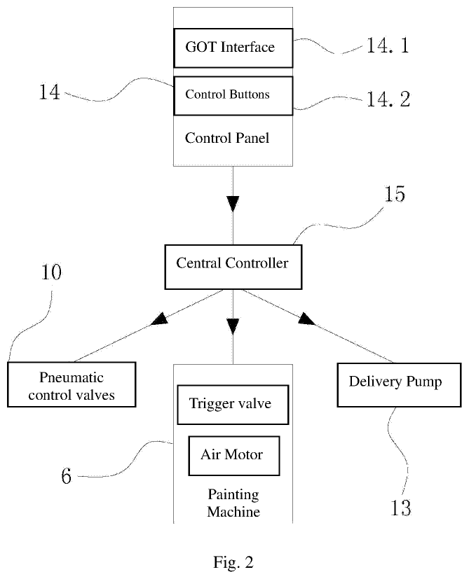

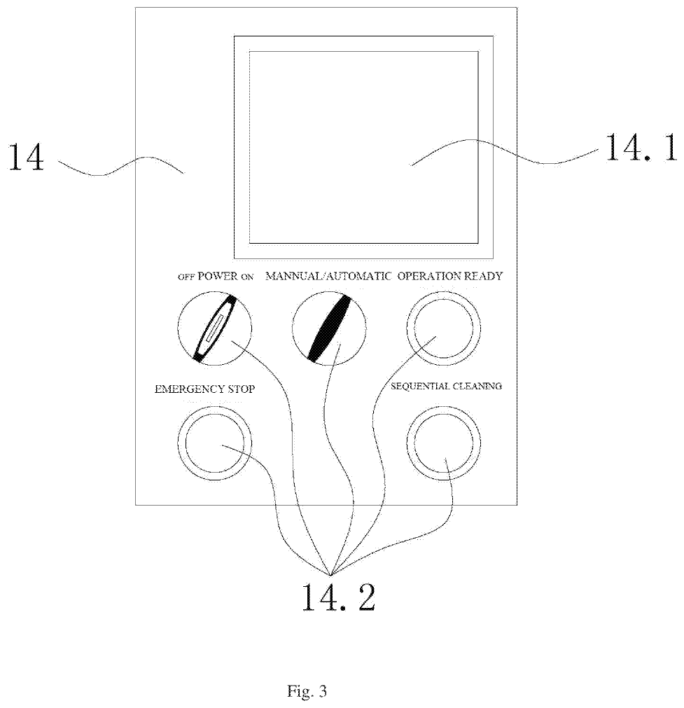

As shown in FIGS. 1 to 3, a control system of the off-line cleaning apparatus for the painting machine according to this embodiment comprises a control panel 14 and a central controller 15. The control panel 14, the painting machine 6, the delivery pump 10, and the control valves 7 are electrically connected with the central controller 15. The central controller 15 is preferably a PLC, which, on the one hand, is used to control operation of the control valves 7 and the delivery pump 10, as well as a trigger valve and the air motor in the paining machine 6, and on the other hand, is used to collect speed information of the air motor in the painting machine 6. The control panel, as a control platform manipulated by an operator, is used to send instructions to the central controller 15. The control valves 7 are preferably pneumatic control valves. Specifically, the cleaning modes of the off-line cleaning apparatus are programmed and written by the central controller 15, which include a manual cleaning mode and an automatic cleaning mode. The manual cleaning mode means that the operator directly controls the timing of solvent spraying, the number of solvent injections, an interval between two solvent spraying and the total cleaning duration through the control panel 14. The automatic cleaning mode means that several pre-set cleaning sequence types are included which have one or more differences in the timing of solvent injection, the number of solvent injections, the interval between two solvent injections and the total cleaning duration, and the operator only needs to select one cleaning sequence type on the control panel 14, and the central controller 15 automatically completes a corresponding cleaning process. Corresponding to the above cleaning modes, the control panel 14 is provided with a GOT interface 14.1 and control buttons 14.2. The operator selects a cleaning mode and cleaning objects on the GOT interface 14.1, and at the same time operates in real time the delivery pump 10 and the control valves 7, as well as the trigger valve, the air motor and other components in the painting machine 6 in the manual cleaning mode, so as to control the cleaning process and the test process. In addition, the GOT interface 14.1 also displays speed information of the air motor in the painting machine 6 collected by the central controller 15 during the test of the painting machine 6, which provides reference for the operator to judge whether the painting machine 6 meets the requirements of normal functions. The control buttons 14.2 are used to start the off-line cleaning apparatus and select a cleaning mode. The control buttons 14.2 mainly include a power switch, a manual/automatic switch, an operation ready button, an emergency stop button, and a sequence cleaning button. The power switch is a knob switch turned with a key for starting or stopping the off-line cleaning apparatus, including an “OFF” position representing power off and an “ON” position representing power on. The manual/automatic switch is a knob switch for switching the cleaning modes, which includes a “manual” position representing the manual cleaning mode and an “automatic” position representing the automatic cleaning mode. The operation ready button is a button with a light, which is used to start the manual cleaning mode. When the manual/automatic switch is turned to the “manual” position, the light of the operation ready button is on. The manual cleaning mode can be started only when the operation ready button lights up. The emergency stop button is also a button with a light, which is used to stop emergently the off-line cleaning apparatus. After the off-line cleaning apparatus is stopped emergently, the light of the emergency stop button is on. The sequential cleaning button is also a button with a light, which is used to start the automatic cleaning mode. After the manual/automatic switch is turned to the “automatic” position and cleaning object(s) (the painting machine 6 or the mixer pipes 5) are selected, the light of the sequential cleaning button twinkles. The light of the sequential cleaning button is on always after the sequential cleaning starts.

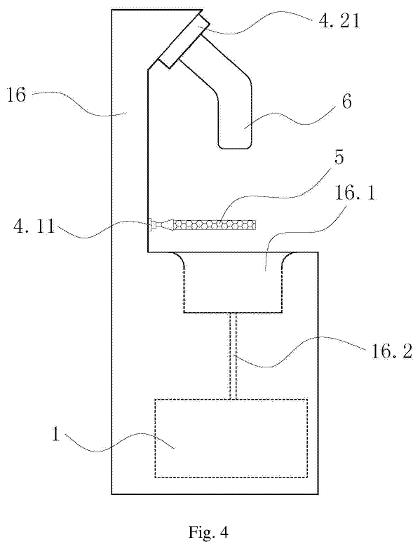

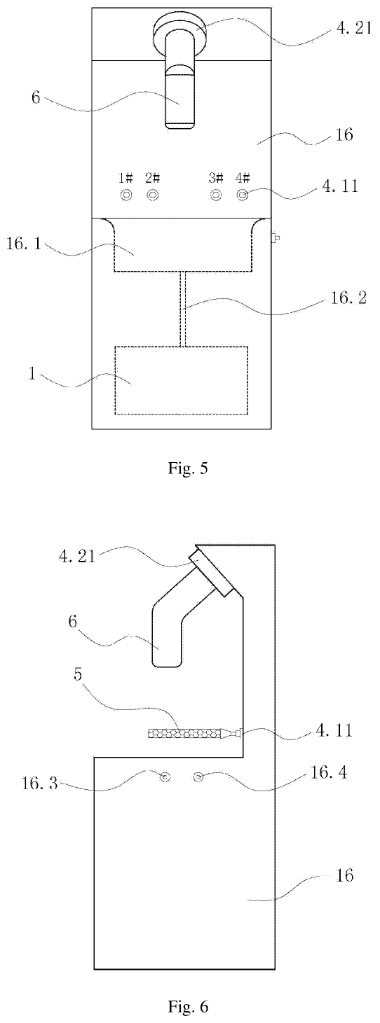

Preferably, as shown in FIGS. 4 to 6, the off-line cleaning apparatus further includes a body 16. The solvent tank 1, the solvent pipe 2, the compressed air pipe 3, the main cleaning pipe 4, and the test pipe 11 are all arranged in the body 16. The control panel 14 can be directly disposed on the body 16, or can be disposed on a control box independently of the body 16. The mixer pipe interfaces 4.11 and the painting machine interface 4.21 are mounted to the body 16, and the body 16 is provided with a recycling tank 16.1. The solvent tank 1 is disposed below the recycling tank 16.1, and the recycling tank 16.1 is provided with a recycling pipe 16.2 communicating with the solvent tank 1. The mixer pipe interfaces 4.11 and the painting machine interface 4.21 are arranged above the recycling tank 16.1, and a spray nozzle of the painting machine 6 faces the recycling tank 16.1 after the painting machine 6 is installed to the painting machine interface 4.21. Based on the above structure, the solvent after cleaning the mixer pipes 5 and the painting machine 6 flows into the recycling tank 16.1, and then flows into the solvent tank 1 through the recycling pipe 16.2, so that a solvent circulation system is formed, which reduces solvent consumption, reduces cleaning costs, and avoids environmental pollution caused arbitrary discharge of sewage. In addition, the first cleaning branch pipe 4.1 is provided with a solvent filling port, and the operator can add solvent to the solvent circulation system through the solvent filling port, which is simple and convenient to operate. Furthermore, one side of the body 16 is also provided with a first air interface 16.3 communicating with the compressed air pipe 3 and a second air interface 16.4 communicating with the test pipe 11. The first air interface 16.3 and the second air interface 16.4 are convenient to receive the compressed air of the workshop, so that the existing compressed air can be used to clean the mixer pipes 5 and the painting machine 6 and to test the painting machine 6, thereby saving energy.

Preferably, as shown in FIG. 1, in order to enhance versatility of the off-line cleaning apparatus, the test pipe 11 is also provided with a valve testing branch pipe 11.5, and the valve testing branch pipe 11.5 is provided with a trigger valve interface 11.51 for testing a trigger valve and a color-changing valve interface 11.52 for testing a color-changing valve. The trigger valve interface 11.51 is used to separately test whether the trigger valve removed from the painting machine 6 functions normally, and the color-changing valve interface 11.52 is used to separately test whether the color-changing valve removed from the painting machine 6 functions normally. In order to facilitate regulation, the valve testing branch pipe 11.5 is provided with an air pressure regulating valve 12, a stop valve 9 and a pressure gauge 17. It should be pointed out that the valve testing branch pipe 11.5 is an additional multifunctional pipe, and it is generally disposed outside the body 16.

The operation process of the off-line cleaning apparatus for the painting machine according to this embodiment includes an operation procedure of cleaning mixer pipes, an operation procedure of cleaning the painting machine, and an operation procedure of testing the painting machine. The operation procedure of cleaning the mixer pipes 5 specifically comprises the following steps: first installing the mixer pipes 5 to the mixer pipe interface 4.11; then turning the power switch with the key to start the off-line cleaning apparatus; and selecting the number of the first cleaning branch pipes 4.1 to be cleaned on the GOT interface 14.1 and selecting a cleaning mode; if the manual cleaning mode is selected, the operation ready button with the light on is pressed to start to clean the mixer pipes 5, and at the same time operations of starting the delivery pump 10, connecting the compressed air pipe 3, and opening the relevant control valves are completed on the GOT interface 14.1, so as to manually control the entire cleaning process of the mixer pipes 5; if the automatic cleaning mode is selected, a type of sequential cleaning is selected according to requirements on the GOT interface 14.1, and then the sequential cleaning button with twinkling light is pressed to start to clean the mixer pipes 5, and the entire process of cleaning the mixer pipes 5 is automatically controlled by the central controller 15. The operation procedure of cleaning the painting machine 6 specifically comprises the following steps: first installing the painting machine 6 to the painting machine interface 4.21, with its spray nozzle facing the recycling tank 16.1; turning the power switch with the key to start the off-line cleaning apparatus; and selecting to clean the painting machine 6 on the GOT interface 14.1 and selecting a cleaning mode; if the manual cleaning mode is selected, the operation ready button with the light on is pressed to start to clean the painting machine 6, and at the same time operations of starting the delivery pump 10, connecting the compressed air pipe 3, opening the relevant control valves, and opening the trigger valve in the painting machine 6 are completed on the GOT interface 14.1, so as to manually control the process and duration of cleaning the painting machine 6; if the automatic cleaning mode is selected, a type of sequential cleaning is selected according to requirements on the GOT interface 14.1, and then the sequential cleaning button with twinkling light is pressed to start to clean painting machine 6, and the entire process of cleaning the painting machine 6 is automatically controlled by the central controller 15. The operation procedure of testing the painting machine 6 specifically comprises the following steps: after cleaning of the painting machine 6, first selecting the function of testing speed on the GOT interface 14.1; then completing operations of connecting the test pipe 11 and starting the air motor in the painting machine 6 on the GOT interface 14.1; and observing the speed of the painting machine 6 on the GOT interface 14.1 so as to judge whether the painting machine 6 meets the requirements of normal use according to the speeds. It should be pointed out that during the cleaning of the mixer pipes 5, any one or more of the mixer pipes 5 can be cleaned by selecting the number of the mixer pipes 5. Moreover, only one cleaning type can be selected at a time in the automatic cleaning mode. In addition, the selection of the cleaning mode can be achieved by turning the manual/automatic switch on the control panel 14.

In summary, the off-line cleaning apparatus for the painting machine according to an embodiment of the invention mainly comprises a body 16 as well as the solvent tank 1, the solvent pipe 2, the compressed air pipe 3, the main cleaning pipe 4 and the test pipe 11 arranged in the body 16. The solvent tank 1 communicates with the main cleaning pipe 4 through the solvent pipe 2 which is provided with a delivery pump 10. The compressed air pipe 3 communicates with the main cleaning pipe 4 for providing compressed air to the main cleaning pipe 4. The main cleaning pipe 4 is provided with first cleaning branch pipes 4.1 and a second cleaning branch pipe 4.2. The body 16 is provided with a mixer pipe interface 4.11 communicating with first cleaning branch pipes 4.1 and a painting machine interface 4.21 communicating with a second cleaning branch pipe 4.2. The test pipe 11 communicates with the painting machine interface 4.21 for testing the speed of the painting machine 6. Compared with the prior art, the invention has the following beneficial effects.

1. The off-line cleaning apparatus solves the problem of paint black spots on bumpers caused by paint scales, and reduces the time and consumables for bumper repair while ensuring the painting quality of bumpers. After calculation, the annual saving of wool balls is about RMB 43,321 yuan, the polishing wax about RMB 934.2 yuan, and the polishing heads about RMB 511.302 yuan.

2. The off-line cleaning apparatus prolongs the service life of the mixer pipes 5 and the painting machine 6, and reduces consumption of spare parts. After calculation, about 16 mixer pipes 5 are saved every year, and the cost is about RMB 11.1600 yuan.

3. The off-line cleaning apparatus reduces the workload of maintenance of the painting machine 6, improves the efficiency of maintenance of the painting machine 6, and ensures the effectiveness of the painting machine 6 after it goes online.

4. The off-line cleaning apparatus reduces the consumption of solvent, saves cleaning costs, and avoids environmental pollution caused by arbitrary discharge of sewage. After calculation, about 10 L cleaning solvent can be saved every year, and the cost is about RMB 39,360 yuan.

It should be understood that the terms “first”, “second”, and the like are used in the invention to describe various information, but the information should not be limited to these terms. These terms are only used to distinguish the same type of information from each other. For example, without departing from the scope of the invention, “first” information may also be referred to as “second” information, and similarly, “second” information may also be referred to as “first” information.

The above are the preferred embodiments of the invention. It should be pointed out that for those skilled in the art, without departing from the principle of the invention, several improvements and modifications can be made, and these improvements and modifications are also considered to be in the protection scope of the invention.

1. An off-line cleaning apparatus for a painting machine, wherein the off-line cleaning apparatus for a painting machine comprises a solvent tank, a solvent pipe, a compressed air pipe, and a main cleaning pipe; the solvent tank communicates with the main cleaning pipe through the solvent pipe, the compressed air pipe communicates with the main cleaning pipe; and the main cleaning pipe is provided with first cleaning branch pipes equipped with mixer pipe interfaces for cleaning mixer pipes and a second cleaning branch pipe equipped with a painting machine interface for cleaning a painting machine.

2. The off-line cleaning apparatus for the painting machine according to claim 1, wherein each of the solvent pipe, the compressed air pipe, the first cleaning branch pipes and the second cleaning branch pipe is provided with a control valve.

3. The off-line cleaning apparatus for the painting machine according to claim 2, wherein the off-line cleaning apparatus for the painting machine further comprises a control panel and a central controller; the painting machine, the control panel, and the control valves are all electrically connected with the central controller.

4. The off-line cleaning apparatus for the painting machine according to claim 3, wherein the central controller is a PLC.

5. The off-line cleaning apparatus for the painting machine according to claim 1, wherein the off-line cleaning apparatus for the painting machine further comprises a test pipe, and the test pipe is provided with a bearing air branch pipe, an atomization air branch pipe, an inner shaping air branch pipe and an outer shaping air branch pipe, which all communicate with the painting machine interface.

6. The off-line cleaning apparatus for the painting machine according to claim 5, wherein the off-line cleaning apparatus for the painting machine further comprises a body in which the solvent tank, the solvent pipe, the compressed air pipe, the main cleaning pipe and the test pipe are arranged; the mixer pipe interfaces and the painting machine interface are fixed to the body; and the body is also provided with a first air interface communicated with the compressed air pipe and a second air interface communicated with the test pipe.

7. The off-line cleaning apparatus for the painting machine according to claim 6, wherein the body is provided with a recycling tank, and the solvent tank is arranged below the recycling tank; the recycling tank is provided with a recycling pipe communicating with the solvent tank; the mixer pipe interfaces and the painting machine interface are arranged above the recycling tank, and a spray nozzle of the painting machine is facing the recycling tank when the painting machine is installed to the painting machine interface.

8. The off-line cleaning apparatus for the painting machine according to claim 5, wherein the test pipe is further provided with a valve testing branch pipe, and the valve testing branch pipe is provided with a trigger valve interface for testing a trigger valve and a color-changing valve interface for testing a color-changing valve.

9. The off-line cleaning apparatus for the painting machine according to claim 1, wherein the solvent pipe is provided with a delivery pump.

10. The off-line cleaning apparatus for the painting machine according to claim 1, wherein each of the first cleaning branch pipes is provided with a solvent filling port.

11. The off-line cleaning apparatus for the painting machine according to claim 2, wherein the solvent pipe is provided with a delivery pump.

12. The off-line cleaning apparatus for the painting machine according to claim 3, wherein the solvent pipe is provided with a delivery pump.

13. The off-line cleaning apparatus for the painting machine according to claim 4, wherein the solvent pipe is provided with a delivery pump.

14. The off-line cleaning apparatus for the painting machine according to claim 5, wherein the solvent pipe is provided with a delivery pump.

15. The off-line cleaning apparatus for the painting machine according to claim 6, wherein the solvent pipe is provided with a delivery pump.

16. The off-line cleaning apparatus for the painting machine according to claim 2, wherein each of the first cleaning branch pipes is provided with a solvent filling port.

17. The off-line cleaning apparatus for the painting machine according to claim 3, wherein each of the first cleaning branch pipes is provided with a solvent filling port.

18. The off-line cleaning apparatus for the painting machine according to claim 4, wherein each of the first cleaning branch pipes is provided with a solvent filling port.

19. The off-line cleaning apparatus for the painting machine according to claim 5, wherein each of the first cleaning branch pipes is provided with a solvent filling port.

20. The off-line cleaning apparatus for the painting machine according to claim 6, wherein each of the first cleaning branch pipes is provided with a solvent filling port.
